(19) United States
(12) Patent Application Publication
(10) Pub. No.: US 2018/0299585 A1
(43) Pub. Date: Oct. 18, 2018

(54) Lens Module

(71) Applicant: Chuandong Wei, Shenzhen (CN)

(72) Inventor: Chuandong Wei, Shenzhen (CN)

(73) Assignee: AAC Technologies Pte. Ltd., Singapore City (SG)

(21) Appl. No.: 15/680,271

(22) Filed: Aug. 18, 2017

(30) Foreign Application Priority Data
Apr. 15, 2017 (CN) 201710248122.6

(51) Int. Cl. G02B 1/10; G02B 7/02

(52) U.S. Cl. CPC G02B 1/10; G02B 13/004; G02B 7/026; G02B 7/021

(57) ABSTRACT

The present disclosure provides a lens module. The lens module includes a lens barrel, and at least one lens located in the lens barrel. The surface of the lens is covered with chromogenic material. Alternatively, the lens could be formed by glass or plastic mixed with chromogenic agent.

### FIELD OF THE PRESENT DISCLOSURE

The present disclosure relates to optical imaging technology, especially for a lens module used for various electronic equipment.

### DESCRIPTION OF RELATED ART

Recent years, with a development of imaging technology and an emerging of an electronic product with an imaging function, an optical imaging lens has been extensively applied in various products, and improved and optimized constantly. Currently, a direction of improving most of imaging lenses is how to make the imaging lens smaller and thinner, and choose a proper lens with a good degree of adaptability of optical characteristics while making the imaging lens smaller and thinner, and study how to integrate them together to guarantee a good imaging result. However, during current imaging, there is always unnecessary stray light entering into the lens that impacts the imaging quality, therefore, during manufacturing the lens, it is required to check the lens and remove the unnecessary stray light, and it is difficult to judge the path of the stray light in the lens module currently, therefore, the imaging quality of the lens is worse, and finding out the unnecessary stray light during imaging is a technical problem that needs to be solved urgently.

Therefore it is necessary to provide a lens module for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative cross-sectional view of a lens module in accordance with an exemplary embodiment of the present disclosure, showing stray lights irradiate on lenses of the lens module.

FIG. 2 is an illustrative cross-sectional view of a lens used in the lens module in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

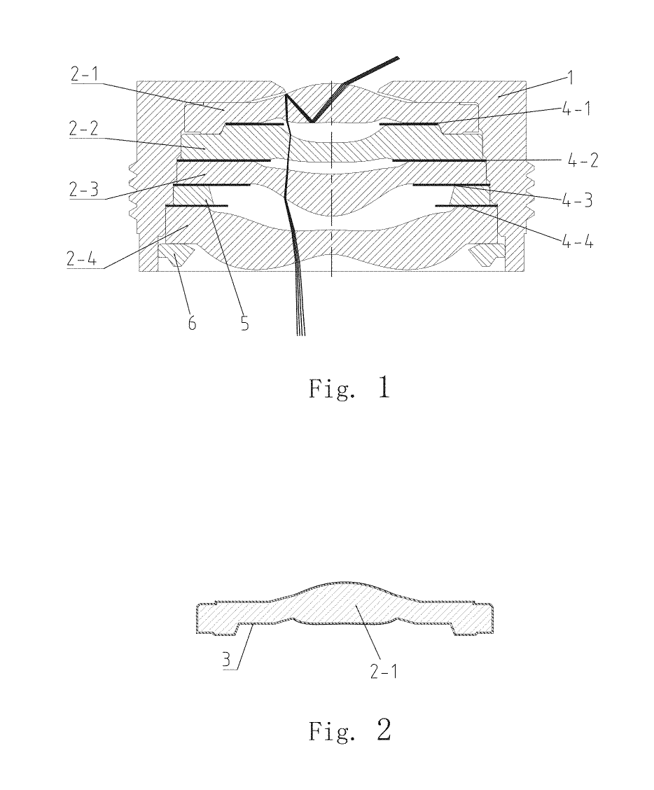

An exemplary embodiment of the present disclosure relates to a lens module. As shown in FIGS. 1-2, the lens module includes a lens barrel 1 and a lens module in the lens barrel 1, and the lens module comprises at least one piece of lens. The lens is made of glass or plastic. In this embodiment, the lens module contains a plurality of lenses. As shown in FIG. 1, the lens module takes incudes 4 lenses, and these four lenses include the lens 2-1, the lens 2-2, the lens 2-3 and the lens 2-4, and the surfaces of various lenses are covered with chromogenic material 3.

Because the surfaces of the lenses are covered with chromogenic material 3, while checking the lens after installing the lens, if any stray light enters into the lens, the chromogenic material 3 will make the stray light show a color in the lens, at which the worker can determine the location of the stray light by the color shown on the stray light, and remove the stray light by adjusting the light angle or adjusting the location of the corresponding parts etc, in order to improve an imaging quality of the lens ultimately.

In this embodiment, the chromogenic material 3 is a chromogenic agent, and the chromogenic agent may be a single-color chromogenic agent or a colorful chromogenic agent by wavelength, spray the chromogenic agent onto the surfaces of various lenses as needed, and the operation is simple and convenient.

Meanwhile, the lens module also includes a shading piece, as shown in FIG. 1, in this embodiment, there are four pieces of shading pieces: the shading piece 4-1, the shading piece 4-2, the shading piece 4-3 and the shading piece 4-4, in which, the shading piece 4-1 is set between an image side of the lens 2-1 and an object side of the lens 2-2, and the shading 4-2 is set between the image side of the lens 2-2 and the object side of the lens 2-3, and the shading piece 4-3 is attached by the image side of the lens 2-3, and the shading piece 4-4 is attached by the object side of the lens 2-4. In order to determine a correct location where the stray light is irradiating into the lens, the surfaces of various shading pieces are also covered with chromogenic material (not drawn in the figure).

Meanwhile, the lens module also includes a shading board 5, in this embodiment, the shading board 5 is set between the image side of the lens 2-3 and the object side of the lens 2-4, and the surface of the shading board 5 is also covered with chromogenic material in order to determine the correct location where the stray light is irradiating into the lens (not drawn in the figure).

In order to fix and retain various lenses into the lens barrel 1, the lens module also includes a ring retaining member 6 for retaining the lens, in this embodiment, the ring retaining member 6 leans the image side of the lens 2-4, and fixes and retains the lens module into the lens 1, and the surface of the ring retaining member 6 is also covered with chromogenic material in order to determine the correct location where the stray light is irradiating into the lens.

In this embodiment, the surfaces of various lenses are covered with chromogenic material 3, and the chromogenic material 3 is a chromogenic agent sprayed on the surfaces of various lenses directly. Optionally an alternatively, the lens could be directly injected and molded by plastic particles mixed with chromogenic material.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A lens module including:
a lens barrel;
at least one lens located in the lens barrel; wherein
a surface of the lens is covered with chromogenic material.

2. The lens module as described in claim 1, wherein the chromogenic material is chromogenic agent, and sprayed directly on the surface of the lens.

3. The lens module as described in claim 1 further including a shading piece located by an object side of the lens or/and an image side of the lens, wherein, a surface of the shading piece is covered by chromogenic material.

4. The lens module as described in claim 1 further including a shading board located by an object side of the lens or/and an image side of the lens; wherein, a surface of the shading board is covered chromogenic material.

5. The lens module as described in claim 1 further including a ring retaining member for retaining the lens in the lens barrel, wherein a surface of the ring retaining member is covered with chromogenic material.

6. A lens module including:
a lens barrel;
at least one lens located in the lens barrel; wherein
the lens is directly injected and molded by plastic particles mixed with chromogenic material.

7. The lens module as described in claim 6 further including a shading piece located by an object side of the lens or/and an image side of the lens; wherein, a surface of the shading piece is covered chromogenic material.

8. The lens module as described in claim 6 further including a shading board located by an object side of the lens or/and an image side of the lens; wherein, a surface of the shading board is covered chromogenic material.

9. The lens module as described in claim 6 further including a ring retaining member for retaining the lens in the lens barrel, wherein a surface of the ring retaining member is covered with chromogenic material.
